(19) United States
(12) Patent Application Publication
(10) Pub. No.: US 2020/0346232 A1
(43) Pub. Date: Nov. 5, 2020

(54) MATRIX FILM DEPOSITION SYSTEM

(71) Applicant: SHIMADZU CORPORATION, Kyoto-shi, Kyoto (JP)

(72) Inventors: Kenta TERASHIMA, Kyoto-shi, Kyoto (JP); Koretsugu OGATA, Kyoto-shi, Kyoto (JP)

(73) Assignee: SHIMADZU CORPORATION, Kyoto-shi, Kyoto (JP)

(21) Appl. No.: 16/760,752

(22) PCT Filed: Nov. 30, 2017
(86) PCT No.: PCT/JP2017/043146

§ 371 Date: Apr. 30, 2020

(51) Int. Cl. B05B 7/24; B05B 7/02; B05B 12/14; G01N 1/28; H01J 49/04; G01N 27/64; H01J 49/16

(52) U.S. Cl. CPC B05B 7/24; B05B 7/02; B05B 12/14; H01J 49/164; H01J 49/045; G01N 27/64; G01N 1/2813

(57) ABSTRACT

In a system for depositing a matrix film by nebulizing a matrix solution onto a sample plate P to which a sample is attached, a chamber 10 housing a sample stage 11 to which a sample plate is attached, a nebulizing nozzle 20 for nebulizing the matrix solution onto the sample stage, a gas inlet 14 formed in the chamber, replacement gas suppliers 40, 41, 42, 43, 47 for supplying a replacement gas to the gas inlet, and replacement gas diffusers 15, 17 for diffusing a flow of the replacement gas in the chamber are provided. According to such a configuration, it is possible to perform gas replacement in the chamber while preventing the formation of a humidity gradient due to the gas flow of the replacement gas. As a result, the humidity in the chamber is kept constant and uniform, and the size of a crystal grain formed on the sample plate and the extraction efficiency of the sample components by the matrix solution can be stabilized.

### TECHNICAL FIELD

The present invention relates to a matrix film deposition system for depositing a film of a matrix substance on a sample plate which is to be used for performing mass spectrometry imaging using a matrix assisted laser desorption/ionization (MALDI) method.

### BACKGROUND ART

The MALDI method is an ionization technique suitable for an analysis of a sample which barely absorbs laser light or one which is easily damaged by laser light (such as proteins). In this technique, a matrix substance which easily absorbs laser light and which is easily ionized is previously mixed in a sample to be measured and the obtained mixture is irradiated with laser light to ionize the sample. Generally, the matrix substance is added to a sample as a solution, and this matrix solution incorporates a measurement target substance contained in the sample. Subsequently, it is dried and the solvent in the solution vaporizes to form crystal particles of the matrix substance containing the measurement target substance. Then, those particles are irradiated with laser light, whereby the measurement target substance is ionized due to interaction among the measurement target substance, matrix substance, and laser light. The MALDI method has been widely used in the areas of bioscience and others since it enables an analysis of polymer compounds having high molecular weights without significantly dissociating them, and furthermore, since it has a high sensitivity and is suitable also for microanalysis.

In recent years, a mass spectrometry imaging (MS imaging) method for directly visualizing a two-dimensional distribution of biomolecules, metabolites, or the like on a slice of biological tissue using a MALDI mass spectrometer has been attracting attention. In the mass spectrometry imaging method, a two-dimensional image representing the intensity distribution of ions having a specific mass-to-charge ratio can be obtained on a sample such as a slice of biological tissue. Therefore, for example, by obtaining the distribution of substances specific to pathological tissues such as cancer, various applications in the medical, drug discovery, and life science fields, such as grasping the spread of disease and confirming the therapeutic effects of medication, etc. are expected.

General methods for preparing a sample, i.e., adding a matrix substance to a sample in the mass spectrometric imaging method include a method (hereinafter referred to as spray method) of spraying and applying the matrix solution onto a plate where the sample is put (see Patent Literature 1, for example). FIG. 7 shows a schematic configuration of a matrix film deposition system for preparing a sample by a spray method. This matrix film deposition system includes a chamber 80 in which a sample stage 81 to which a sample plate P is attached is housed, and a nebulizing nozzle 70 for spraying a matrix substance onto the sample plate P. The nebulizing nozzle 70 includes a gas pipe 72 through which the nebulizing gas flows, and a solution pipe 71 through which the matrix solution flows. These have a double pipe structure in which the solution pipe 71 is inserted inside the gas pipe 72, and the tip of the solution pipe 71 is surrounded by the tip of the gas pipe 72. Further, a needle 73 is inserted into the center of the solution pipe 71, and the tip of the needle 73 slightly projects from the tip of the solution pipe 71. The inside of the solution pipe 71 is filled with a matrix solution, and its proximal end is inserted into a solution container 75 containing the matrix solution. The proximal end of the gas pipe 72 is connected to a gas source 74 such as a gas cylinder. Note that, during nebulizing, the chamber 80 is not closed but opened to the atmosphere in order to release gas ejected into the chamber 80 from the tip of the gas pipe 72 to the outside.

Since the tip of the solution pipe 71 is surrounded by the tip of the gas pipe 72 as described above, when the high-pressure nebulizing gas supplied from the gas source 74 is ejected from the tip of the gas pipe 72, the vicinity of the tip of the solution pipe 71 is depressurized (Venturi effect), and the matrix solution is drawn out from the tip. The matrix solution drawn out from the tip of the solution pipe 71 is sheared by the nebulizing gas into fine droplets, and the fine droplets are ejected from the nozzle 70 along with the flow of the nebulizing gas. At this time, the matrix solution flows along the needle 73 so as to improve the shearing efficiency of the matrix solution by the nebulizing gas, allowing the droplets to be further miniaturized. The matrix solution injected from the nebulizing nozzle 70 as described above adheres to the sample plate P on the sample stage 81 facing the nebulizing nozzle 70.

When the matrix solution nebulized as described above falls on the sample plate P to which a sample such as a slice of biological tissue is attached in advance, components (sample components) contained in the sample are extracted by the matrix solution, and then a large number of crystal particles containing the sample components and the matrix substances are formed on the sample plate P through vaporization of the solvent in the solution.

### CITATION LIST

### Patent Literature

Patent Literature 1: JP 2016-114400 A ([0004])

### SUMMARY OF INVENTION

### Technical Problem

In the mass spectrometry imaging method, a high spatial resolution is required to obtain a mass spectrometry image that accurately reflects the distribution of a target substance. One of the major factors that determine the spatial resolution in mass spectrometry imaging using MALDI is a particle size of the matrix substance in the prepared sample, and the smaller the particle size is, the higher spatial resolution is obtained.

However, in the above-described spray method, there has been a problem that it is difficult to perform mass spectrometry imaging with a consistent spatial resolution because the size of the crystal particles formed on the sample plate may differ depending on the timing of nebulizing.

In sample preparation by the spray method, the detection sensitivity of the sample component sometimes varies depending on the timing of nebulizing.

The present invention has been made in order to solve the above-mentioned problems, and an object of the present invention is to provide a matrix film deposition system for MALDI which can realize stable spatial resolution and detection sensitivity when performing mass spectrometry imaging.

### Solution to Problem

The present inventors have conducted intensive studies to solve the above-mentioned problems, and found that the humidity in the chamber at the time of nebulizing has an effect on the size and shape of the crystal particles formed on the sample plate, and the extraction efficiency of the sample components by the matrix solution, thereby the present invention is achieved.

That is, a matrix film deposition system according to the present invention made to solve the above problems includes:

a) a chamber configured to house a sample stage to which a sample plate is attached;

b) a nebulizing nozzle for nebulizing a solution containing a matrix substance used for matrix assisted laser desorption/ionization method toward the sample stage;

c) a gas inlet formed in the chamber;

d) a replacement gas supplier configured to supply a replacement gas to the gas inlet; and

e) a replacement gas diffuser configured to diffuse a flow of the replacement gas in the chamber.

According to the above configuration, since the air in the chamber is replaced by the replacement gas supplied by the replacement gas supplier, the humidity in the chamber can be always maintained constant irrespective of the humidity of the outside air at the time of nebulizing. Therefore, there is no variation in the size of the crystal particles formed on the sample plate due to the timing of nebulizing as in the related art, and it is possible to achieve a stable spatial resolution in mass spectrometry imaging. Simply supplying the replacement gas into the chamber may cause a humidity gradient by the gas flow of the replacement gas. This impairs the uniformity of humidity in the chamber, or disturbs the nebulizing flow by the gas flow of the replacement gas, and the uniformity of the matrix application on the sample plate may be impaired. Such a problem can be prevented in the present invention by diffusing the flow of the replacement gas by the replacement gas diffuser. In addition, in mass spectrometry imaging, in order to detect a target substance with high sensitivity, components in a sample need to be efficiently extracted by a matrix solution during sample preparation. According to the present invention, nebulizing under constant and uniform humidity as described above allows the extraction efficiency of sample components by the matrix solution nebulized on the sample plate to be maintained at a constant level, thus stabilizing the detection sensitivity of target components in mass spectrometry imaging.

In the matrix film deposition system according to the present invention, the replacement gas diffuser may preferably include a replacement gas diffusion plate which is a plate disposed between the gas inlet and the sample stage and provided with a plurality of holes.

Alternatively, in the matrix film deposition system according to the present invention, the replacement gas diffuser may include a replacement gas diffusion pipe which is a pipe disposed in the chamber, with one end connected to the gas inlet, and having a plurality of openings formed in a peripheral surface.

It is preferable that the matrix film deposition system according to the present invention further includes,

f) a gas outlet formed in the chamber, in which

the replacement gas diffuser has a bypass plate which is disposed between the sample plate and the gas outlet and configured to detour a gas flow toward the gas outlet.

In addition, it is preferable that the matrix film deposition system according to the present invention further includes,

g) a gas outlet formed in the chamber, in which

the chamber is closed except for the gas inlet and the gas outlet during nebulizing by the nebulizing nozzle.

In addition, it is preferable that the matrix film deposition system according to the present invention further includes,

h) a controller configured to controlling the replacement gas supplier to supply the replacement gas to the gas inlet during nebulizing the solution by the nebulizing nozzle.

Further, in the matrix film deposition system according to the present invention, it is preferable that the replacement gas supplier is configured to supply the replacement gas to the gas inlet at a flow rate larger than a flow rate of the nebulizing gas ejected from the nebulizing nozzle.

Further, in the matrix film deposition system according to the present invention, it is preferable that the replacement gas supplier is configured to supply the replacement gas to the gas inlet, so that the replacement gas is ejected from the gas inlet at a linear velocity lower than a linear velocity of the nebulizing gas ejected from the nebulizing nozzle in the chamber.

In addition, it is preferable that the matrix film deposition system according to the present invention further includes:

i) a gas source; and a nebulizing gas supplier configured to supply an inert gas supplied from the gas source to the nebulizing nozzle, in which

the replacement gas supplier is configured to supply the inert gas supplied from the gas source provided in the nebulizing gas supplier to the gas inlet as the replacement gas.

### Advantageous Effects of Invention

As described above, according to the matrix film deposition system of the present invention, by maintaining the humidity in the chamber constant, it is possible to stabilize the size of the particle composed of crystals formed on the sample plate and the extraction efficiency of the sample components by the matrix solution, and as a result, it is possible to achieve stable spatial resolution and detection sensitivity in mass spectrometry imaging.

### BRIEF DESCRIPTION OF DRAWINGS

FIG. 1 is a schematic diagram showing a main configuration of a matrix film deposition system according to one embodiment of the present invention.

FIG. 2 is a flowchart showing an operation of a control unit during deposition by the matrix film deposition system of the embodiment.

FIG. 3 is a view showing a simulation result of a gas flow in a chamber when an opening ratio of a diffusion plate is set to 100%.

FIG. 4 is a view showing a simulation result of a gas flow in a chamber when a diffusion plate (opening ratio: 9.7%) as shown in FIG. 5A is used.

FIGS. 5A-5C are views showing a configuration example of a diffusion plate according to the present invention, in which FIG. 5A shows a configuration having circular openings on the entire surface, FIG. 5B shows a configuration having circular openings in a partial region, and FIG. 5C shows a configuration having square linear openings.

FIGS. 6A-6B are views showing a configuration example of a diffusion pipe according to the present invention, in which FIG. 6A is a perspective view of the diffusion pipe, and FIG. 6B is a perspective view showing a mounting position of the diffusion pipe in a chamber.

FIG. 7 is a schematic diagram showing a schematic configuration of a conventional spray-type matrix film deposition system.

### DESCRIPTION OF EMBODIMENTS

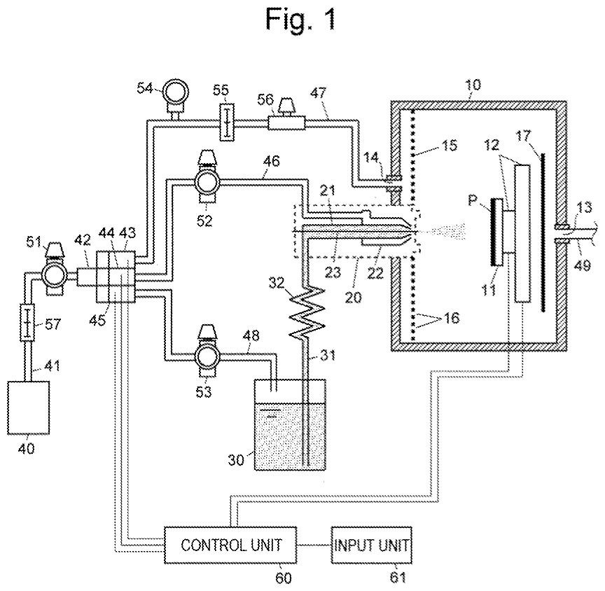

Hereinafter, embodiments for carrying out the present invention will be described with reference to the drawings. FIG. 1 is a schematic diagram illustrating a main configuration of a matrix film deposition system according to the present embodiment. The matrix film deposition system according to the present embodiment has a chamber 10 in which a sample plate P is housed, and a nebulizing nozzle 20 for spraying a matrix solution (a solution containing a matrix substance) onto the sample plate P.

Inside the chamber 10, a sample stage 11 on which the sample plate P is mounted and an XY stage 12 for moving the sample stage 11 are housed. On the wall surface of the chamber 10 facing the sample stage 11, a nebulizing nozzle 20 is attached, and a gas inlet 14 as a through hole is formed. In addition, it is preferable that both the nebulizing nozzle 20 and the gas inlet 14 are arranged near the center of the wall surface. This makes it possible to make the nebulizing flow and the replacement gas flow axially symmetrical in the up, down, left, and right directions, and to perform nebulizing and gas replacement uniformly and efficiently. On the other hand, a gas outlet 13 which is a through hole is formed on a wall surface of the chamber 10 on the rear side of the sample stage 11. Further, a door (not shown) for inserting and removing the sample plate P is provided on the wall surface of the chamber 10 which is orthogonal to the wall surface on which the nebulizing nozzle 20 is attached. When the door is closed, the chamber 10 is closed except for the gas inlet 14 and the gas outlet 13.

The nebulizing nozzle 20 has a double pipe structure including a solution pipe 21 and a gas pipe 22 which is coaxial with the solution pipe 21 and is disposed as an outer cylinder so as to surround the solution pipe 21. The solution pipe 21 has an inner diameter of about 0.3 mm at the tip portion, and a needle 23 for guiding the solution at the time of nebulizing is inserted into the center of the solution pipe 21. The tips of the solution pipe 21 and the gas pipe 22 are substantially at the same position in the length direction of the pipes 21 and 22, and the tip of the needle 23 slightly projects from the tip of the solution pipe 21.

One end of a solution supply pipe 31 is connected to the proximal end of the solution pipe 21, and the other end of the solution supply pipe 31 is disposed at the lower portion of a solution container 30 which is a sealed container containing the matrix solution (lower than the center of the solution container 30 in the height direction, preferably near the bottom surface). In addition, a resistance pipe 32 is inserted in an intermediate portion of the solution supply pipe 31. As the resistance pipe 32, a pipe having a sufficiently large resistance value compared to the resistance value at the tip of the solution pipe 21 of the nebulizing nozzle 20, for example, a capillary pipe having an inner diameter of 0.075 mm and a length of 20 mm is used. As the resistance pipe 32, a capillary made of silica, a capillary made of PEEK (polyetheretherketone) resin, or the like can be used. However, in view of durability, it is preferable to use a PEEK capillary.

One end of a nebulizing gas pipe 46 is connected to the proximal end of the gas pipe 22, and the other end of the nebulizing gas pipe 46 is connected to a gas source 40 via a manifold (multi-branch pipe) 42 and a common pipe 41. The gas source 40 includes, for example, a gas cylinder or a gas generator and has a constant and low humidity (20% or less, preferably 15% or less), and sends an inert gas having an absolute pressure higher than the atmospheric pressure to the common pipe 41. As such a gas source 40, it is preferable to use a liquefied nitrogen gas cylinder or a nitrogen gas generator. The manifold 42 has one inlet end and three outlet ends, the aforementioned common pipe 41 is connected to the inlet end, and the aforementioned nebulizing gas pipe 46 is connected to one of the three outlet ends. One of the remaining two outlet ends of the manifold 42 is connected to one end of a pressurizing gas pipe 48, and the other end of the pressurizing gas pipe 48 is disposed near the ceiling inside the solution container 30 (at least higher than the center of the solution container 30 in the height direction). One end of a replacement gas pipe 47 is connected to the remaining one outlet end of the manifold 42, and the other end of the replacement gas pipe 47 is connected to the gas inlet 14 of the chamber 10. Note that an exhaust pipe 49 leading to a draft chamber (not shown) is connected to the gas outlet 13 provided in the chamber 10.

Solenoid valves are mounted on the three outlet ends of the manifold 42, respectively. Hereinafter, of these solenoid valves, the one provided at the outlet end to which the replacement gas pipe 47 is connected is referred to as a gas replacement valve 43, the one provided at the outlet end to which the nebulizing gas pipe 46 is connected is referred to as a nebulizing valve 44, and the one provided at the outlet end to which the pressurizing gas pipe 48 is connected is referred to as a pressurizing valve 45. In the present embodiment, the gas source 40, the common pipe 41, the manifold 42, the gas replacement valve 43, and the replacement gas pipe 47 correspond to a replacement gas supplier in the present invention, and the gas source 40, the common pipe 41, the manifold 42, the nebulizing valve 44, and the nebulizing gas pipe 46 correspond to a nebulizing gas supplier in the present invention.

The common pipe 41, the nebulizing gas pipe 46, and the pressurizing gas pipe 48 are provided with manual pressure regulating valves 51, 52, and 53, respectively. Further, the common pipe 41 is further provided with a flow meter 57, and the replacement gas pipe 47 is provided with a pressure gauge 54, a flow meter 55, and a manual flow regulating valve 56. Hereinafter, the gases flowing through the replacement gas pipe 47, the nebulizing gas pipe 46, and the pressurizing gas pipe 48 may be referred to as a replacement gas, a nebulizing gas, and a pressurizing gas, respectively.

Further, the matrix film deposition system according to the present embodiment includes a control unit 60 for controlling the operations of the XY stage 12 and the solenoid valves 43, 44, and 45, and the control unit 60 is connected to an input unit 61 for a user to input a setting and an instruction. The function of the control unit 60 is realized by causing a computer having a CPU and a memory to execute a predetermined control program.

The matrix film deposition system according to the present embodiment includes two replacement gas diffusers which are a diffusion plate 15 for diffusing the replacement gas introduced from the gas inlet 14 into the chamber 10, and a bypass plate 17 for diffusing a gas (air or replacement gas) flow by detouring the gas flow toward the gas outlet 13. The diffusion plate 15 is a plate provided with a plurality of openings 16, and for example, a punching metal or the like can be used. In the matrix film deposition system shown in FIG. 1, the internal space of the chamber 10 is divided into two by the diffusion plate 15, and the replacement gas introduced into one space from the gas inlet 14 passes through any of the plurality of openings 16 provided on the diffusion plate 15 and flows into the other space (the space where the sample stage 11 is disposed). On the other hand, the bypass plate 17 is a plate whose area is larger than the opening area of the gas outlet 13 and smaller than the cross-sectional area of the chamber 10 in a plane orthogonal to the central axis of the nebulizing flow, and is disposed in front of the gas outlet 13 in a state of being in parallel with the wall surface on which the gas outlet 13 is provided and being separated from the wall surface by several centimeters.

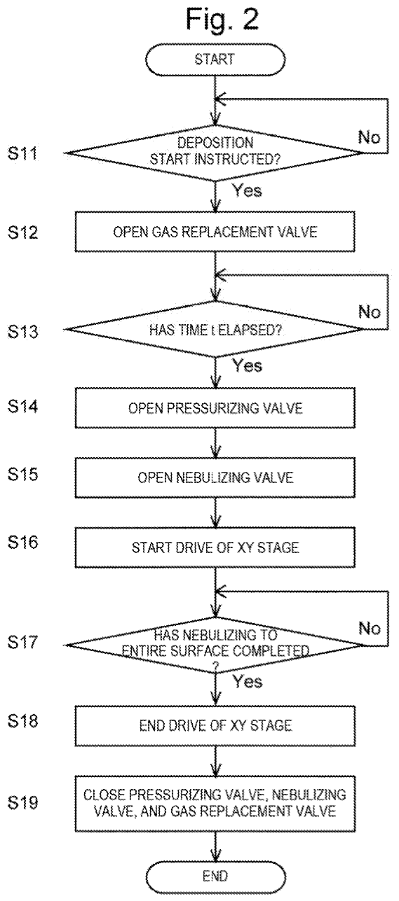

Hereinafter, a procedure for preparing a sample using the matrix film deposition system according to the present embodiment will be described with reference to the flowchart of FIG. 2. When deposition is performed by the matrix film deposition system according to the present embodiment, first, a worker (hereinafter, referred to as a user) opens a door of the chamber 10 and attaches a sample plate P on which a sample such as a tissue slice is stuck to the sample stage 11. Subsequently, the user closes the door of the chamber 10, manually adjusts the opening degree of the pressure regulating valves 51, 52, 53 and the opening degree of the flow regulating valve 56 as necessary, and then operates the input unit 61 to input an instruction to start deposition. The pressure regulating valve 52 and the flow regulating valve 56 regulate the flow rate of the replacement gas to be larger than the flow rate of the nebulizing gas during nebulizing. This makes it possible to increase the replacement speed of the gas in the chamber and suppress a change in humidity in the chamber due to the nebulizing of the matrix solution. However, in order to reduce disturbance of the nebulizing flow due to the replacement gas, it is preferable that the ejection linear velocity of the replacement gas in the chamber 10 be sufficiently lower than the ejection linear velocity of the nebulizing gas. This can be realized, for example, by making the opening area of the gas inlet 14 sufficiently larger than the opening area of the gas pipe 22. In the present embodiment, the pressure regulating valves 51, 52, 53 and the flow regulating valve 56 are manually operated. However, these are assumed to be driven by a motor, and the control unit 60 may be configured to regulate the opening degrees of the pressure regulating valves 51, 52, 53 and the flow regulating valve 56 based on a set value input in advance by the user via the input unit 61.

When an instruction to start deposition is input from the input unit 61 (Yes in step S11), the control unit 60 first sends a control signal to the gas replacement valve 43 to open the valve 43 (step S12). As a result, the inert gas supplied from the gas source 40 flows through the manifold 42 and the replacement gas pipe 47 into one space partitioned by the diffusion plate 15 inside the chamber 10. Then, the inert gas is diffused by passing through the opening 16 formed in the diffusion plate 15, and flows into the other space (the space where the sample plate P is disposed) in the chamber 10 at a low flow rate. The inert gas that has flowed into the space in which the sample plate P is disposed is further diffused by colliding with and bypassing the bypass plate 17 disposed in front of the gas outlet 13, and is then discharged from the gas outlet 13.

Thereafter, when a predetermined time t has elapsed (Yes in step S13), the control unit 60 sends a control signal to the pressurizing valve 45 to open the valve 45 (step S14). As for the time t, a time sufficient for completely replacing the air in the chamber 10 with the inert gas (replacement gas) is determined by the user in advance based on the volume of the chamber 10, the flow rate of the replacement gas, and the like, and is stored in the control unit 60. By opening the pressurizing valve 45 as described above, the inert gas supplied from the gas source 40 to the manifold 42 also flows into the pressurizing gas pipe 48. As a result, the inert gas (pressurizing gas) is introduced into the upper space of the solution container 30 from the tip of the pressurizing gas pipe 48, and the liquid surface of the matrix solution in the solution container 30 is pressurized by the pressurizing gas. As a result, the matrix solution is introduced into the solution supply pipe 31 and is discharged from the solution pipe 21 of the nebulizing nozzle 20 via the resistance pipe 32.

Subsequently, the control unit 60 sends a control signal to the nebulizing valve 44 to open the valve 44 (step S15). Thereby, the inert gas supplied from the gas source 40 to the manifold 42 further flows also into the nebulizing gas pipe 46. Here, the pressurizing valve 45 and the nebulizing valve 44 are opened in this order, but these valves 44 and 45 may be opened in reverse order or may be opened at the same time.

As described above, the inert gas (nebulizing gas) is ejected from the tip of the gas pipe 22 of the nebulizing nozzle 20, and the matrix solution flowing out of the tip of the solution pipe 21 is sheared by the nebulizing gas to become fine droplets, and the droplets are ejected from the nebulizing nozzle 20 together with the nebulizing gas.

When the nebulizing of the matrix substance is started, the control unit 60 subsequently sends a control signal to the XY stage 12 (step S16). Thereby, the XY stage 12 moves the sample stage 11 so that the matrix solution is nebulized uniformly on the entire surface of the sample plate P.

Note that the gas replacement valve 43 is kept open and the replacement gas is continuously introduced from the gas inlet 14 even while the matrix solution is nebulized onto the sample plate P as described above.

Thereafter, when the matrix solution is nebulized on the entire surface of the sample plate P (Yes in step S17), the control unit 60 stops the XY stage 12 (step S18), further, the gas replacement valve 43, the nebulizing valve 44, and the pressurizing valve 45 are closed to stop the replacement of the gas in the chamber 10 with the inert gas and the nebulizing of the matrix substance onto the sample plate P (step S19). As described above, when the deposition of the matrix film on the sample plate P is completed, the user opens the door of the chamber 10 and takes out the sample plate P. Thereafter, when deposition is performed continuously on another sample plate P, a new sample plate P is set on the sample stage 11, and the above operation is repeatedly performed.

Note that, here, the pressurizing valve 45 and the nebulizing valve 44 are opened (that is, nebulizing is started) when a predetermined time t has elapsed since the gas replacement valve 43 was opened. Instead of this, for example, when the user instructs to start nebulizing the matrix solution (that is, when the nebulizing start instruction is input from the input unit 61 to the control unit 60), the pressurizing valve 45 and the nebulizing valve 44 may be opened. Further, the nebulizing of the matrix solution may be started when a predetermined amount of the replacement gas is supplied to the chamber 10 after the gas replacement is started. In this case, for example, the measurement result by the flow meter 55 or the flow meter 57 is input to the control unit 60, and the control unit 60 calculates the supply amount of the replacement gas from the gas replacement start time based on the input.

As described above, in the matrix film deposition system according to the present embodiment, since the air in the chamber 10 is replaced by the inert gas supplied from the gas source 40, regardless of the humidity of the outside air, the humidity in the chamber 10 can always be kept constant. Therefore, there is no variation in the size of the particle composed of crystals formed on the sample plate P due to the timing of nebulizing as in the conventional case, and it is possible to always perform mass spectrometry imaging with stable spatial resolution. Further, in the matrix film deposition system according to the present embodiment, the inert gas supplied into the chamber 10 is diffused by the diffusion plate 15 and then flows at a low flow rate into the space where the sample plate P is disposed in the chamber 10, and therefore, the formation of a humidity gradient in the space due to the inert gas is suppressed. Further, since the flow of the inert gas toward the outlet 13 is diffused by bypassing the bypass plate 17 inside the chamber 10, the formation of the humidity gradient in the chamber 10 can be suppressed more effectively. Therefore, by providing the diffusion plate 15 and the bypass plate 17, it is possible to prevent the size of the matrix crystals on the sample plate P from becoming uneven due to the influence of the humidity gradient. Further, since the speed of the flow of the inert gas (replacement gas) can be reduced by the diffusion plate 15, the influence of the gas on the nebulizing flow can be reduced, and uniform matrix application to the sample plate can be achieved. Further, in the matrix film deposition system according to the present embodiment, by performing nebulizing under a constant humidity, the extraction efficiency of the sample component by the matrix solution nebulized on the sample plate P can be maintained at a constant level. Therefore, the detection sensitivity of the target component in mass spectrometry imaging can be stabilized. Further, by using a low-humidity gas (dry gas) as the inert gas, it is possible to reduce the size of the particle composed of crystals formed on the sample plate and achieve high resolution.

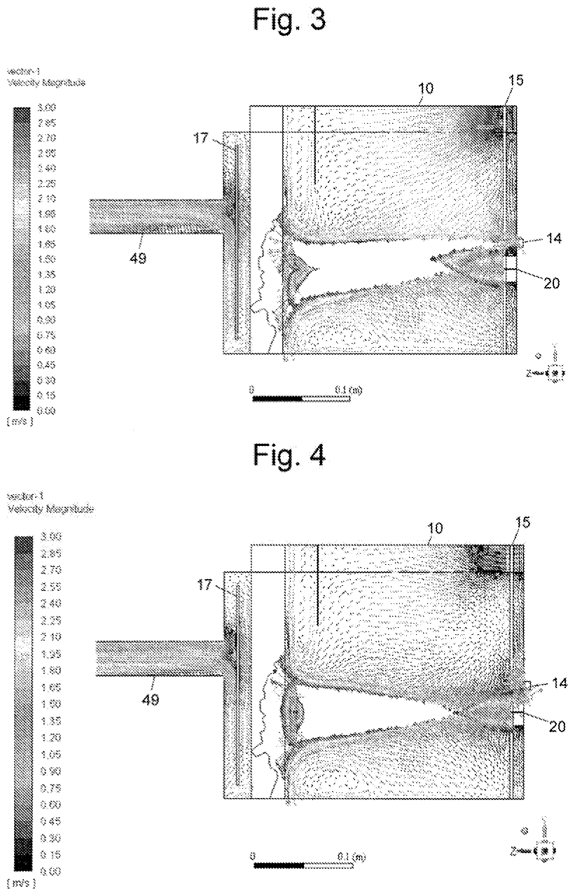

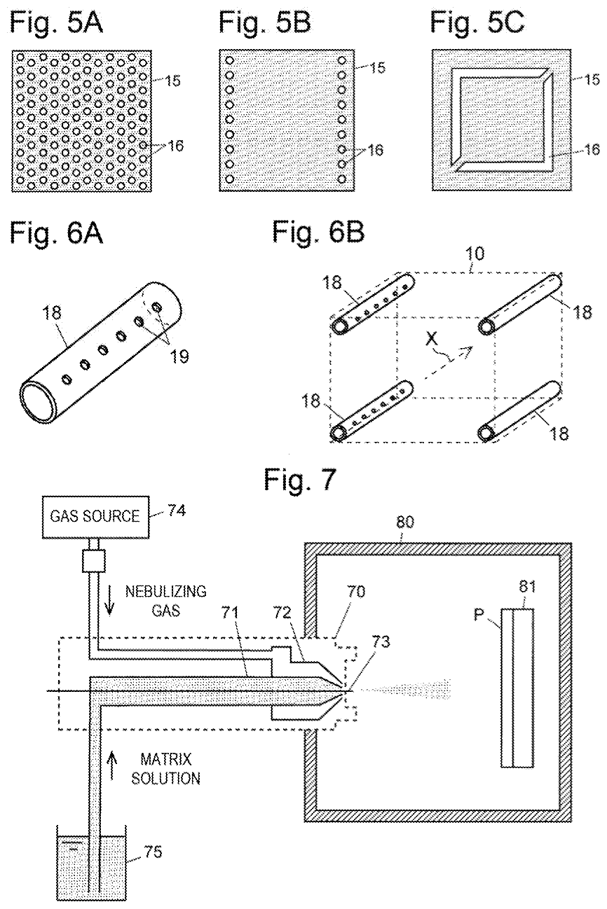

FIG. 3 and FIG. 4 show simulation results showing the gas flow in the chamber 10 (vector representation of the flow velocity distribution in the center cross-section of the chamber 10). FIG. 3 shows a case where the opening ratio of the opening 16 of the diffusion plate 15 is 100% (that is, a case where the diffusion plate does not substantially exist), and FIG. 4 shows a case where the diffusion plate 15 (opening ratio: 9.7%) having the openings 16 on the entire surface is used as shown in FIG. 5A. In these figures, the length of the vector represents the speed of the gas flow, and the density of the vector represents the density of the gas molecules. As is apparent from these figures, when the diffusion plate 15 is not used (FIG. 3), since the replacement gas is directly introduced into the chamber 10 without passing through the diffusion plate 15, the speed of the gas flow in the chamber 10 due to the replacement gas is relatively large, and the flow of the replacement gas affects the shape of the nebulizing gas flow. On the other hand, when the diffusion plate 15 is used (FIG. 4), the replacement gas is diffused by the diffusion plate 15 and introduced into the space where the sample plate P in the chamber 10 is disposed at a relatively low flow rate. The influence of the gas flow of the replacement gas on the nebulizing gas flow is also reduced.

Note that, as the diffusion plate 15, for example, a plate having the openings 16 on the entire surface as shown in FIG. 5A may be used, or a plate having the openings 16 only in a partial region (for example, at peripheral edge portions) as shown in FIG. 5B may be used. As the size (opening area) of the opening 16 increases, the speed of replacing the gas in the chamber 10 increases, but the effect of diffusing the flow of the replacement gas decreases. On the other hand, as the opening 16 is smaller, the effect of diffusing the flow of the replacement gas is improved, but the speed of replacing the gas in the chamber 10 becomes slower. Therefore, the size of the opening 16 may be appropriately determined based on a desired gas replacement speed and uniformity of the matrix crystal. However, in order to surely diffuse the flow of the replacement gas, the size of each opening 16 is preferably made smaller than the size of the opening at the outlet portion of the gas inlet 14 for the replacement gas. The shape of the opening 16 is not limited to a circle, but may be a polygon, a line, or the like, and for example, as shown in FIG. 5C, may be a shape obtained by cutting a partial region of the diffusion plate 15 into a square line.

Further, instead of the diffusion plate 15 as described above, a pipe having a plurality of openings 19 on a peripheral surface (hereinafter, referred to as a diffusion pipe 18) as shown in FIG. 6A may be disposed in the chamber 10. The diffusion pipe 18 has its tip closed and its proximal end connected to the gas inlet 14. As shown in FIG. 6B, it is preferable to arrange the diffusion pipe(s) 18 along one or a plurality of sides (four sides in FIG. 6B) parallel to the central axis X of the nebulizing nozzle 20 among the respective sides of a rectangular parallelepiped space in the chamber 10.

As described above, the replacement gas diffuser in the present invention can take various forms as long as it has a function of diffusing the flow of the replacement gas introduced into the chamber 10. However, if the diffusion plate 15 is a flat plate having openings 16 as shown in FIGS. 5A to 5C, since the replacement gas diffuser can be formed only by forming openings 16 in a metal plate by a punching press or the like and then mounting the metal plate in the chamber 10, the production becomes easier. Furthermore, in addition to such easiness of manufacture, by forming a plate shape having openings 16 on the entire surface as shown in FIG. 5A, it is possible to further improve the uniformity of the replacement gas in the chamber 10.

Note that, in the matrix film deposition system according to the present invention, the gas replacement in the chamber 10 by the replacement gas may be performed only before the start of nebulizing, but as shown in the flowchart of FIG. 2, it is preferable to continue the introduction of the replacement gas even during the nebulizing of the matrix substance.

As described above, the embodiments for carrying out the present invention have been described. However, the present invention is not limited to the above-described embodiments, and may be appropriately changed within the scope of the present invention.

For example, in the above embodiment, the matrix film deposition system according to the present invention performs the nebulizing of the matrix substance by the spray method. However, the present invention is not limited to this, and is also applicable to a device for nebulizing a matrix substance (see Patent Literature 1) by the electrospray deposition (ESD) method.

In the above embodiment, the sample plate P is moved by the XY stage 12. Alternatively, the nebulizing nozzle 20 may be moved in a plane parallel to the sample plate P.

Furthermore, in the above-described embodiment, the matrix solution is delivered by pressurizing the liquid surface of the matrix solution in the solution container 30 with the gas supplied from the gas source 40. However, the matrix solution may be pressurized and delivered by another method, for example, a syringe pump. In addition, a configuration in which the matrix solution is not pressurized or delivered, but the matrix solution in the solution container 75 is sucked into the solution pipe 71 of the nebulizing nozzle 70 by the Venturi effect, as in the conventional matrix film deposition system shown in FIG. 7 may be adopted.

### REFERENCE SIGNS LIST

10, 80 . . . Chamber
11, 81 . . . Sample Stage
12 . . . XY Stage
13 . . . Gas Outlet
14 . . . Gas Inlet
15 . . . Diffusion Plate
16 . . . Opening
17 . . . Bypass Plate
18 . . . Diffusion Pipe
19 . . . Opening
20, 70 . . . Nebulizing Nozzle
21, 71 . . . Solution Pipe
22, 72 . . . Gas Pipe
23, 73 . . . Needle
30, 75 . . . Solution Container
31 . . . Solution Supply Pipe
32 . . . Resistance Pipe
40, 74 . . . Gas Source
41 . . . Common Pipe
42 . . . Manifold
43 . . . Gas Replacement Valve
44 . . . Nebulizing Valve
45 . . . Pressurizing Valve
46 . . . Nebulizing Gas Pipe
47 . . . Replacement Gas Pipe
48 . . . Pressurizing Gas Pipe
49 . . . Exhaust Pipe
51, 52, 53 . . . Pressure Regulating Valve
54 . . . Pressure Gauge
55, 57 . . . Flow Meter
56 . . . Flow Regulating Valve
60 . . . Control Unit
61 . . . Input Unit
P . . . Sample Plate

1. A matrix film deposition system, comprising:
a) a chamber configured to house a sample stage to which a sample plate is attached;
b) a nebulizing nozzle for nebulizing a solution containing a matrix substance used for matrix-assisted laser desorption ionization toward the sample stage;
c) a gas inlet formed in the chamber;
d) a replacement gas supplier configured to supply a replacement gas to the gas inlet; and
e) a replacement gas diffuser configured to diffuse a flow of the replacement gas in the chamber.

2. The matrix film deposition system according to claim 1, wherein the replacement gas diffuser has a replacement gas diffusion plate which is a plate provided with a plurality of holes and disposed between the gas inlet and the sample stage.

3. The matrix film deposition system according to claim 1, wherein the replacement gas diffuser has a replacement gas diffusion pipe which is a pipe disposed in the chamber, with one end connected to the gas inlet, and having a plurality of openings formed in a peripheral surface.

4. The matrix film deposition system according to claim 1, further comprising
f) a gas outlet formed in the chamber, wherein
the replacement gas diffuser has a bypass plate which is disposed between the sample plate and the gas outlet and is configured to detour a gas flow toward the gas outlet.

5. The matrix film deposition system according to claim 1, further comprising
g) a gas outlet formed in the chamber, wherein
the chamber is closed except for the gas inlet and the gas outlet during nebulizing by the nebulizing nozzle.

6. The matrix film deposition system according to claim 1, further comprising
h) a controller configured to control the replacement gas supplier to supply the replacement gas to the gas inlet during nebulizing the solution by the nebulizing nozzle.

7. The matrix film deposition system according to claim 1, wherein the replacement gas supplier is configured to supply the replacement gas to the gas inlet at a flow rate larger than a flow rate of the nebulizing gas ejected from the nebulizing nozzle.

8. The matrix film deposition system according to claim 1, wherein the replacement gas supplier is configured to supply the replacement gas to the gas inlet, so that the replacement gas is ejected from the gas inlet at a linear velocity lower than a linear velocity of the nebulizing gas ejected from the nebulizing nozzle in the chamber.

9. The matrix film deposition system according to claim 1, further comprising:
i) a gas source; and a nebulizing gas supplier configured to supply an inert gas supplied from the gas source to the nebulizing nozzle, wherein
the replacement gas supplier is configured to supply the inert gas supplied from the gas source provided in the nebulizing gas supplier to the gas inlet as the replacement gas.
